(19) United States
(12) Patent Application Publication
(10) Pub. No.: US 2018/0114505 A1
(43) Pub. Date: Apr. 26, 2018

(54) DISPLAY DEVICE AND A METHOD OF DRIVING THEREOF

(71) Applicant: Sharp Kabushiki Kaisha, Osaka (JP)

(72) Inventors: Edward David HEYWOOD-LONSDALE, Oxford (GB); Benjamin John BROUGHTON, Oxford (GB); Nathan James SMITH, Oxford (GB)

(21) Appl. No.: 15/566,330

(22) PCT Filed: Apr. 21, 2016
(86) PCT No.: PCT/JP2016/002145

§ 371 Date: Oct. 13, 2017

(30) Foreign Application Priority Data
Apr. 21, 2015 (GB) 1506777.0

(51) Int. Cl. G09G 5/10; G09G 3/36; G09G 3/00

(52) U.S. Cl. CPC G09G 5/10; G09G 3/3648; G09G 3/003; G02F 2001/134372; G09G 2320/068; G09G 2358/00; G09G 2320/028

(57) ABSTRACT

A method of processing image data for display by a display panel of a display device comprises receiving image pixel data representing an image. In a first mode, the method performs a first mapping of the image pixel data to drive signals, each drive signal for driving a respective pixel or group of pixels of the display panel. The first mapping is arranged to produce an on-axis luminance pattern which is dependent mainly on the image pixel data and an off-axis luminance pattern which is wholly or substantially independent of the image pixel data. The first mapping is arranged, for a pixel or a group of pixels, to map the image pixel data for the pixel or group of pixels to one of a first plurality of preselected drive signals including at least first and second pre-selected drive signals that drive, in use, the pixel or group of pixels of the display panel to produce different on-axis luminance values and that drive, in use, the pixel or group of pixels of the display panel to produce the same or similar off-axis luminance values at at least one off-axis viewing angle. This provides a private display mode. If a public display mode is desired, a second mapping of the image pixel data to a second plurality of drive signals is performed instead of the first mapping. The second mapping is arranged to produce an on-axis luminance pattern which is dependent mainly on the image pixel data and an off-axis luminance pattern which is depend ent mainly on the image pixel data.

### TECHNICAL FIELD

The present invention relates to a display device, for example a liquid crystal display device, that may operate in a private display mode, and which may optionally be switchable between a public display mode and a private display mode. It also relates to a method of operating a display device to obtain a private display mode.

### BACKGROUND ART

There are known a number of different display devices which include some mechanism for reducing the visibility of the device to viewers who are not looking straight on to the device, and a mechanism for returning the device to full visibility. The mechanism to create the private viewing mode typically includes an extra cost, such as more advanced hardware, or a reduced display appearance to the on-axis viewer when the privacy mode is engaged.

Devices incorporating such displays include mobile phones, tablets, Personal Digital Assistants (PDAs), laptop computers, desktop monitors, Automatic Teller Machines (ATMs) and Electronic Point of Sale (EPOS) equipment. Such devices can also be beneficial in situations where it is distracting and therefore unsafe for certain viewers (for example drivers or those operating heavy machinery) to be able to see certain images at certain times, for example an in car television screen while the car is in motion.

To display an image on a display device, the display device typically receives a sequence of sets of image data values, with each set of image data values defining a respective image, or a respective frame of the image in the case of a video image. Each set of image data value is converted into drive signals, for example into pixel electrode voltages, to drive the image display device to show the desired image or frame. The conversion is generally performed using a lookup table, which stores pre-computed values of drive signals corresponding to possible image data values. Methods of providing a private display mode by altering the look up tables used to convert image data values to pixel electrode voltages exist, and examples of such methods are given in Gass et al, US2007/0040780, published on Feb. 22, 2007; Lin, US2007/0242209, published on Oct. 18, 2007; and Broughton et al, WO2008/056553, published on May 15, 2008. In all three it is disclosed how there are different electrode voltages which result in the same apparent on-axis brightness, but lead to different off-axis brightnesses. In particular, there exists a set of voltages which drive the display to display a full range of on-axis brightness levels, including a dark state and a bright state and intermediate levels, which have very similar off-axis brightnesses—thus giving an off-axis contrast ratio very close to 1—which is used in the private mode, and there exists another set of voltages, again covering a dark on-axis state, a bright on-axis state, and intermediate on-axis brightness levels, with a very high off-axis contrast ratio, which is used in the public mode. Thus, for given input image data it is possible to operate the display device in either a public display mode or a private display mode by selecting an appropriate look-up table to convert image data values to the first set or to the second set of pixel electrode drive voltages (or other drive signals). US2007/0040780 further discloses that it is possible to use both voltage ranges in the private mode, but separating them spatially over the area of the display, such that different regions of the screen will be displaying significantly different off-axis appearances, which may increase the privacy strength. In certain embodiments of the above, the two different off-axis brightness ranges may not necessarily have an obvious private and public mode; in fact, as long as the two ranges are different, and, particularly, each on-axis brightness has two or more different corresponding off-axis brightnesses, a privacy effect is possible using spatial masking.

Image processing methods which alter input image data such that, when combined with the currently implemented look up table, the image displayed on the device will be imperceptible to off-axis viewers, exist and are disclosed in Wynne-Powell et al., GB2428152A1, published on Jan. 17, 2007; Broughton et al., WO2009/110128A1, published on Sep. 11, 2009; Broughton et al., WO2011/034209, published on Mar. 24, 2011; and Broughton et al., WO2011/034208, published on Mar. 24, 2011.

Broughton et al, application number U.S. Ser. No. 13/962,164, discloses a method to increase privacy in the case that certain on-axis brightnesses have the property that the contrast between the two off-axis brightnesses is weaker than the contrast for other on-axis brightnesses. Using certain dithering algorithms it is possible to increase the prevalence of on-axis brightnesses for which a stronger privacy effect is possible, at the expense of a further loss of resolution.

These publications disclose methods for processing images such that the on-axis appearance of an image will be largely unchanged, but the off-axis appearance will be selectively altered. In particular, there exists in each disclosure a processing method which typically reduces the apparent resolution of the device, as well as the on-axis contrast ratio, and significantly changes the off-axis appearance. There also exists a second processing method, which reduces the on-axis contrast ratio of the device through a simple scaling process; there now exists, for each image data value, two different configurations for displaying the target brightness, with different off-axis appearances. When optionally combined with a pattern covering the device which specifies which configuration to use in different parts of the device, a strong privacy effect can be achieved.

In US2007/0040780, a particular advantage of the privacy mode disclosed is that there is no resolution loss needed in the private mode. A disadvantage is that a large increase in voltage is required, since it is necessary to replicate every on-axis luminance level. FIG. 1 shows the transmission level (T) as a function of voltage for a device of US2007/0040780 for on-axis (normal) incidence and for ±45° off-axis incidence. FIG. 1 shows there is a choice of off-axis transmission levels for a required on-axis level—for example an on-axis transmission level of 0.25 can be obtained by an applied voltage of approximately 1.3V giving an off-axis transmission level of approximately 0.1 or by an applied voltage of approximately 1.9V giving an off-axis transmission level of approximately 0.4. It can be seen that the maximum required voltage for the private mode is 2.2 Volts, while the total maximum required voltage for the public mode is 1.6 V. This higher voltage may be unfeasible because of the increased power consumption, or because of limitations in the driver electronics.

In WO2011034209, a particular advantage of the privacy mode is that there is no change to the look up tables used to select individual pixel voltage levels. However, in order to provide a choice of off-axis luminance levels at every on-axis luminance target level, the effective resolution of the screen is halved.

In both of the known methods described above, it is imperative that there exists, for every image data value, at least two configurations for processing the data value (that is, two different configurations that will provide an on-axis transmissivity corresponding to the data value). This may be enabled either by the use of an extended voltage driving scheme, or by effective grouping of pixels to produce an averaged luminance in total, but there exist displays for which neither the use of an extended voltage driving range nor grouping pixels to produce averaged luminance provides configurations with sufficiently different off-axis luminances for enough on-axis luminance values to allow a privacy effect. The lack of a suitable voltage driving range may be a limitation of the driver electronics, or a desire to limit the power consumption of the private mode, or any other limitation. There is therefore a need for addressing such displays and processing image data for use on such, which enables a privacy effect despite these limitations.

FIG. 2 is a graph showing multiple normalised off-axis to on-axis luminance curves provided by a display of the type described in WO 2009/110128. The method disclosed in this publication uses the change in data value to luminance curve with viewing angle inherent in many liquid crystal display modes such as “Advanced Super View” (ASV) (IDW'02 Digest, pp 203-206) or Polymer Stabilised Alignment (PSA) (SID'04 Digest, pp 1200-1203). The data values of the image displayed on the LC panel are altered in such a way that the modifications applied to neighbouring pixels effectively cancel out when viewed from the front of the display (on-axis), such that the main image is reproduced, but when viewed from an oblique (off-axis) angle, the modifications to neighbouring pixels result in a net luminance change, dependent on the degree of modification applied, so the perceived image may be altered.

### SUMMARY OF INVENTION

A first aspect of the present invention provides a method of processing image data for display by a display panel of a display device, the method comprising: receiving image pixel data representing an image; and in a first mode, performing a first mapping of the image pixel data to drive signals, each drive signal for driving a respective pixel or group of pixels of the display panel, wherein the first mapping is arranged, for a pixel or group of pixels, to produce an on-axis luminance pattern for the pixel or group of pixels which is dependent mainly on the image pixel data and an off-axis luminance pattern which is wholly or substantially independent of the image pixel data; wherein the first mapping is arranged to map the image pixel data to one of a first plurality of pre-selected drive signals including at least first and second pre-selected drive signals that drive, in use, the pixel or group of pixels of the display panel to produce different on-axis luminance values and that drive, in use, the pixel or group of pixels of the display panel to produce the same or similar off-axis luminance values.

The image pixel data for a subsequent pixel or group of pixels is then processed according to the first mapping to obtain a drive signal for driving the subsequent pixel or group of pixels, and so on.

A method of the invention may be performed in a display device, or it may be performed external to the display device with the determined drive signals then being provided to the display device.

A method of the invention may be used with a display device that (for at least one on-axis luminance required to provide a desired image) does not have multiple pixel configurations that give the desired on-axis luminance and give different off-axis luminances to one another, and so may be used with display devices for which the prior art methods may not be used. This is not the only advantage of the invention however and additionally or alternatively, a method of the invention may be used with a display device that (for all on-axis luminance levels required to provide a desired image) has multiple pixel configurations that give the required on-axis luminance and give different off-axis luminances; in such cases a method of the invention may be used to provide, for example, a better quality on-axis image and/or to allow use of lower drive voltages than prior art methods.

The first mapping may be further arranged to map the image pixel data for a group of adjacent pixels of the display such that, in use, the pixels of the group are driven such that an average on-axis luminance value of the group of pixels is dependent mainly on the image pixel data and such that every pixel of the group of pixels produces the same or similar off-axis luminance value at at least one off-axis viewing angle.

The first plurality of pre-selected drive signals may further include a third drive signal that drives, in use, the pixel or group of pixels of the display panel to produce the same on-axis luminance value as the first drive signal and that drives, in use, the pixel or group of pixels of the display panel to produce a different off-axis luminance value to the first drive signal.

The first plurality of pre-selected drive signals may further include a fourth drive signal that drives, in use, the pixel or group of pixels of the display panel to produce the same on-axis luminance value as the second drive signal and that drives, in use, the pixel or group of pixels of the display panel to produce a different off-axis luminance value to the second drive signal.

The third and fourth drive signals may drive, in use, the pixel or group of pixels of the display panel to produce the same or similar off-axis luminance values as one another.

The first plurality of pre-selected drive signals may further include a fifth drive signal that drives, in use, the pixel or group of pixels of the display panel to produce the same or similar off-axis luminance value as the first and second drive signals and that drives, in use, the pixel or group of pixels of the display panel to produce an on-axis luminance value different to the on-axis luminance value provided by the first drive signal and different to the on-axis luminance value provided by the second drive signal.

The method may comprise selecting whether to drive a pixel or group of pixels of the display with the first drive signal or the third drive signal in accordance with a first predefined pattern.

The method may further comprise selecting whether to drive a pixel or group of pixels of the display with the second drive signal or the fourth drive signal in accordance with either the first predefined pattern or a second, different predefined pattern.

The use of the first and second drive signals that produce different on-axis luminance values is completely effective for display of a binary image, that is an image in which every pixel either has minimal luminance (also referred to as “black” or “off”) or has maximal luminance (also referred to as “white” or “on”). In many cases however it is desired to display an image that has intermediate luminance levels in addition to the minimal and maximal luminance levels. To allow this, the first mapping may be further arranged to map the image pixel data for a group of adjacent pixels of the display such that, in use, the pixels of the group are driven such that an average on-axis luminance value of the group of pixels is dependent mainly on the image pixel data and is intermediate between the on-axis luminance value corresponding to the first drive signal and the on-axis luminance value corresponding to the second drive signal. This allows the display of intermediate luminance levels.

The method may additionally or alternatively comprise compressing all of, or at least a predetermined proportion of, the image pixel data; and performing the first mapping on the compressed image pixel data.

There may, for at least one off-axis luminance value, be n drive signals, n>1, that, in use, drive the display panel to produce said off-axis luminance value or a similar off-axis luminance value and that drive the display panel to produce n different on-axis luminance values; and compressing all of, or at least the predetermined proportion of, the image pixel data may comprise compressing all of, or at least the predetermined proportion of, the image pixel data into the n different on-axis luminance values.

In one example n=2, and in another example n>2.

Performing the first mapping may comprise mapping the image pixel data to modified image pixel data, and applying a predefined mapping to the modified image pixel data to generate the drive signals. Alternatively, the received image pixel data may be directly mapped to drive signals.

The method may further comprise, in a second mode, performing a second mapping of the image pixel data to a second plurality of drive signals for driving the display panel, wherein the second mapping is arranged to produce an on-axis luminance pattern which is dependent mainly on the image pixel data and an off-axis luminance pattern which is dependent mainly on the image pixel data. This provides a public display mode in which an image is visible to both on-axis and off-axis observers.

If performing the first mapping comprises mapping the image pixel data to modified image pixel data, and applying a predefined mapping to the modified image pixel data to generate the drive signals, performing the second mapping may comprise applying the predetermined mapping to the image pixel data. This allows both the private display mode and the public display mode to be effected using a single mapping between pixel data and drive signals, for example with a mapping contained in a preexisting look-up table.

Alternatively, the image pixel data may be mapped according to a first predetermined mapping in the first mode and according to a second, different predetermined mapping in the first mode. This eliminates the need to generate modified image pixel data, but requires that two different mappings are available (and would require two look-up tables if both mappings are pre-stored).

Other aspects and features of the invention are set out in claims 17 to 35.

### BRIEF DESCRIPTION OF DRAWINGS

In the annexed drawings, like references indicate like parts or features:

FIG. 1 Typical on and off-axis transmission levels for liquid crystal display with good wide-view performance, showing a choice of off-axis transmission levels for a required on-axis ratio.

FIG. 2 Typical on and off-axis luminance levels for liquid crystal display with weak wide-view performance, showing choice of off-axis luminance for required on-axis luminance, using pairs of pixels.

FIG. 3 Simulated on- and off-axis transmission levels across a range of voltages

FIG. 4 Simulated plot of off-axis transmission vs on-axis transmission, corresponding to FIG. 3

FIG. 5 Simulated on- and off-axis transmission levels across a range of voltages

FIG. 6 Simulated plot of off-axis transmission vs on-axis transmission, corresponding to FIG. 5

FIG. 7 Simulated on- and off-axis transmission levels across a range of voltages

FIG. 8 Simulated plot of off-axis transmission vs on-axis transmission, corresponding to FIG. 7

FIG. 9 Typical on and off-axis luminance curves across a range of electrode voltages

FIG. 10 On- and off-axis luminance produced by range of all possible configurations of spatial modulator in a display device

FIG. 11 Sample image pattern for spatially separating choice of configuration

FIG. 12 Contrast ratio at different viewing angles, for different sets of configurations

FIG. 13 Simulated image apparent to an on-axis viewer in the private mode

FIG. 14 Simulated image apparent to an off-axis viewer in the private mode

FIG. 15 Simulated image apparent to an off-axis viewer in the private mode when a side image mask is being used

FIG. 16 Simulated on- and off-axis transmission levels across a range of voltages

FIG. 17 schematic block diagram of a display embodying the present invention;

FIG. 18 schematic block flow diagram of a method according to an embodiment of the invention;

FIG. 19 schematic block flow diagram of a method according to an embodiment of the invention.

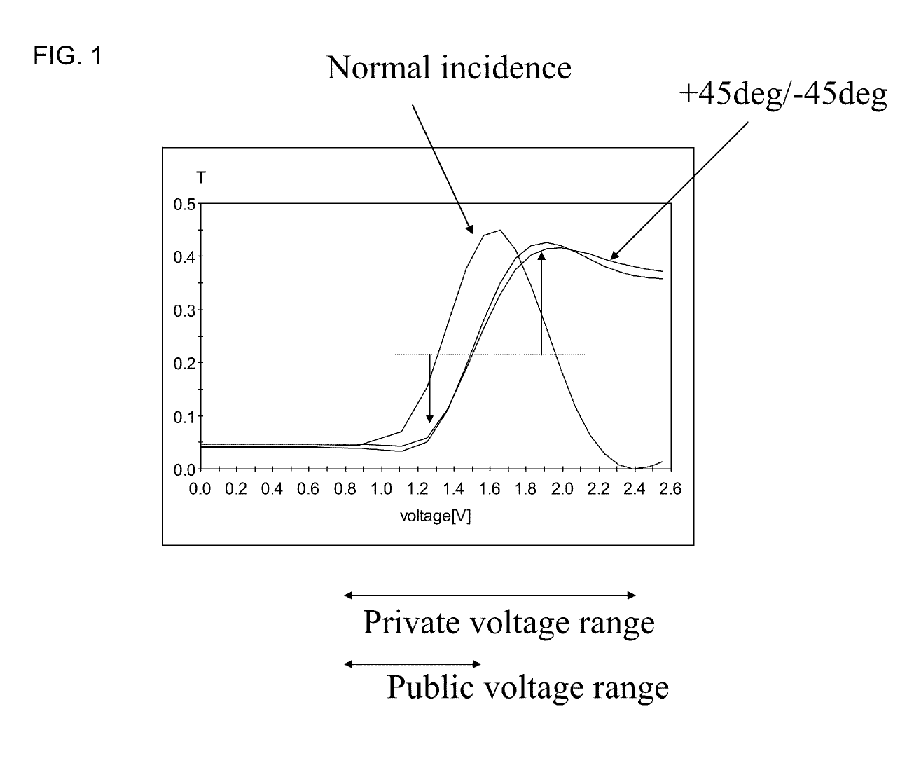

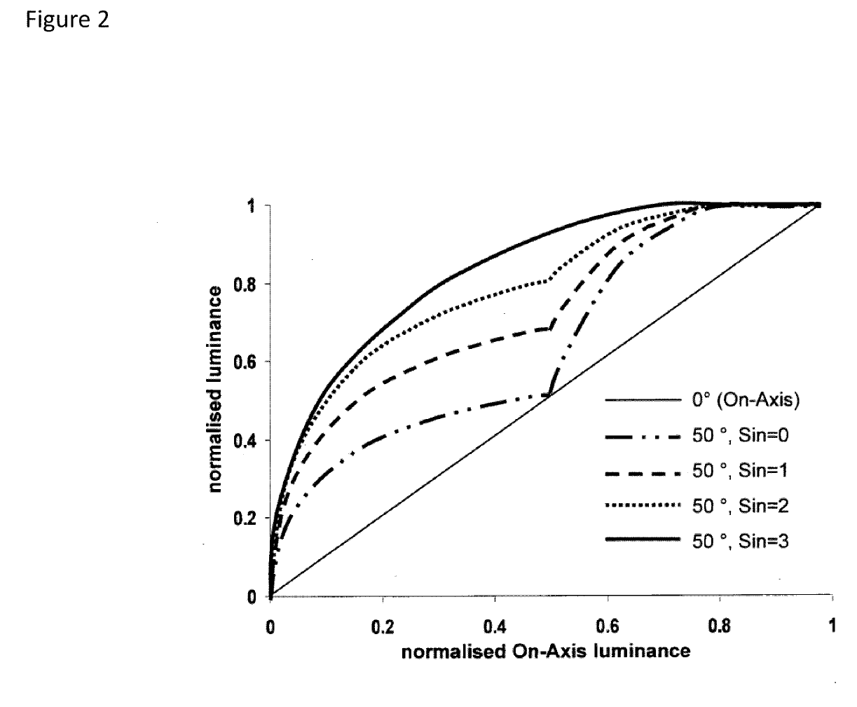

### DESCRIPTION OF EMBODIMENTS

In previous approaches to providing a privacy effect on a display device, the device typically has a favourable characteristic which is needed for the privacy effect to have any strength, where “strength” of the privacy effect refers to the difficulty of reading the screen from off-axis viewing zones. In particular, prior methods require that, for any on-axis luminance level required for display of the desired image, there are two or more different pixel configurations with which it is possible to display that on-axis luminance. It is then possible to choose, for any pixel (or group of pixels), which of these two or more configurations to use. By “configuration” is meant the particular arrangement of the spatial modulator in each subpixel, which has a variable luminance level (the invention may be applied to either a transmissive display device or an emissive display device) depending on its environment. Typically, the configuration of a sub-pixel of a spatial modulator is determined by a drive signal applied to the sub-pixel (the drive signal is usually the electric field applied across the sub-pixel, as in a liquid crystal display or an organic light-emitting diode). In the case when a privacy effect is desired, such that other users of the device will not be able to see an image that is apparent to the main user, the two or more available pixel configurations for a particular on-axis luminance might be chosen so that they present different luminances to one another at angles apart from on-axis. If the choice, of which of the two or more configurations is used, changes across the device, then the apparent introduced contrast visible to the off-axis viewer, when there is none visible to the on-axis viewer, introduces an image masking effect.

In an embodiment of the present invention, it is possible to create a privacy effect even in a case where there is not a choice, across all desired on-axis luminance levels, of two or more configurations that both provide the desired on-axis luminance but that provide different off-axis luminance levels—and where the prior art techniques hence cannot be used. In a certain case, it is possible to achieve a strong privacy effect even when there are no on-axis luminance levels with multiple configuration options that provide the same on-axis luminance but different off-axis luminance levels, if there is at least one off-axis luminance level for which there exist two different configurations which both display this off-axis luminance while displaying non-identical luminance levels to on-axis viewers; or if there are two off-axis luminance levels, which are sufficiently close to each other as to provide a contrast ratio very close to one to the off-axis viewer, such that the screen is in practice difficult to view from an off-axis viewing region, whose corresponding on-axis luminances are sufficiently different that an on-axis viewer will be able to read the screen as intended. The strongest possible privacy effect is when there is a contrast ratio of one between all used configurations, to a viewer located in any off-axis region, even while there is a non-unity contrast ratio between used configurations presented to an on-axis viewer. In practice this is not feasible and a key aim of this method will be to reduce the off-axis contrast as much as possible while preserving the on-axis contrast as much as possible. By “strong privacy effect” or simply “privacy effect” is meant, that an off-axis viewer will typically not be able to easily distinguish between different configurations being used in different regions of the same screen.

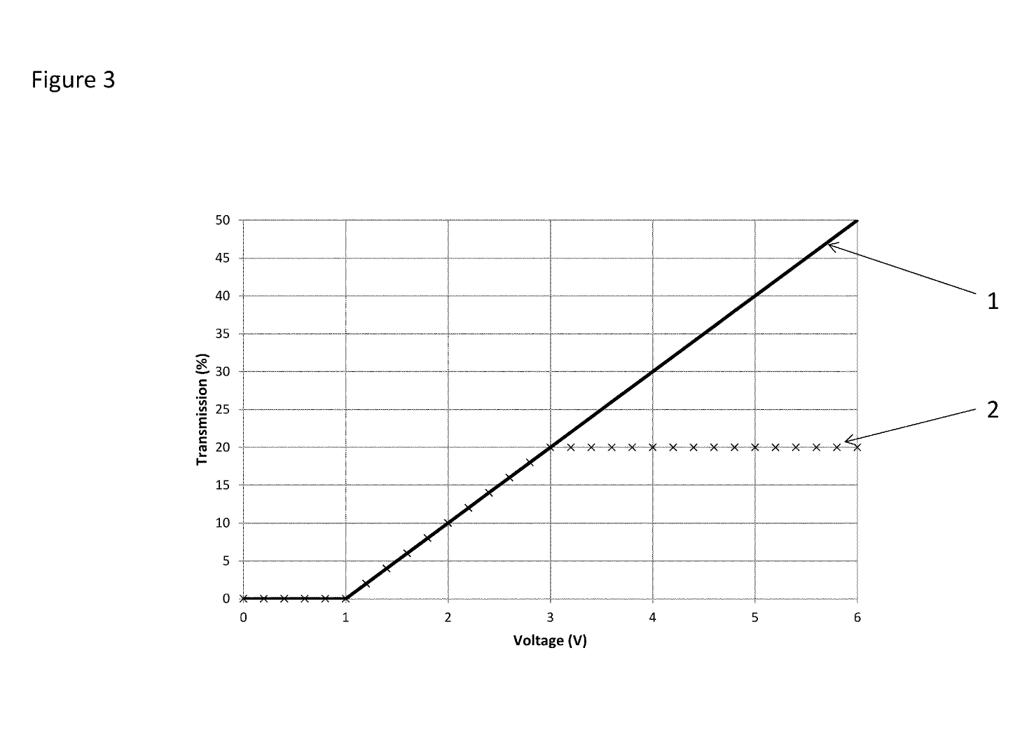

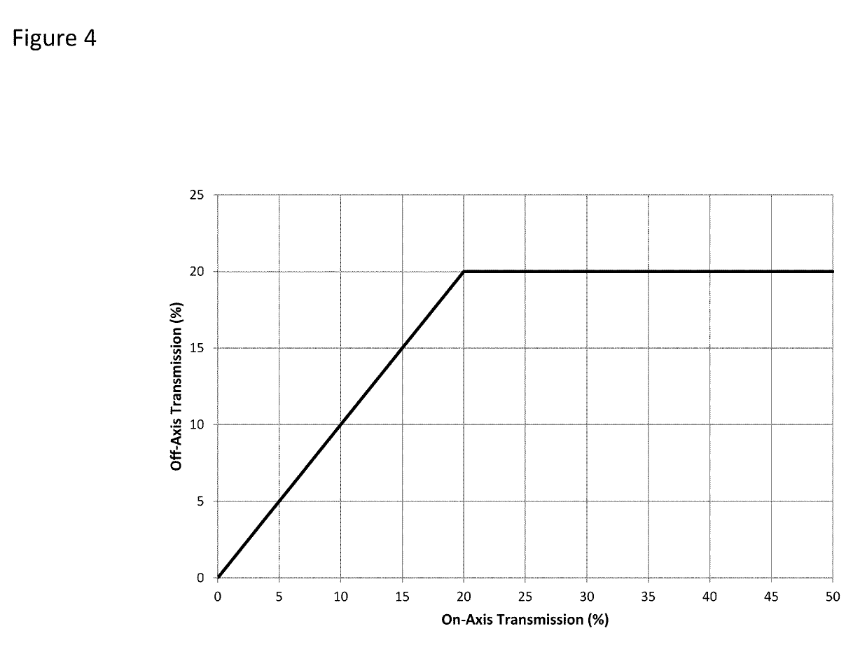

FIG. 3 shows transmissivity against voltage characteristics of one such display which could show a privacy effect. The full line 1 shows the on-axis transmissivity, and the xxxx line 2 shows the off-axis transmissivity. As can be seen there is a range of applied voltages for which the off-axis transmissivity is constant while the on-axis transmissivity increases with voltage, and a privacy effect may be obtained by driving the display between two states with the same off-axis transmissivity. For example, by driving the display at 3V for an OFF state and at 6V for an ON state, an on-axis contrast ratio of 2.5:1 can be achieved, with an off-axis contrast ratio of 1:1 which gives complete privacy. This is further illustrated in FIG. 4, which is a plot of the off-axis transmission of FIG. 3 against the on-axis transmission of FIG. 3.

The present invention therefore obtains a private display mode by using drive signals that include at least first and second pre-selected drive signals that drive, in use, a pixel or group of pixels of the display panel to produce different on-axis luminance values and that drive, in use, the pixel or group of pixels of the display panel to produce the same or similar off-axis luminance values at at least one off-axis viewing angle. Using these two drive signals allows different on-axis luminance values to be obtained and so allows an on-axis image to be displayed, while displaying a uniform, or substantially uniform, luminance at at least one off-axis viewing angle and thereby obtaining a private display mode.

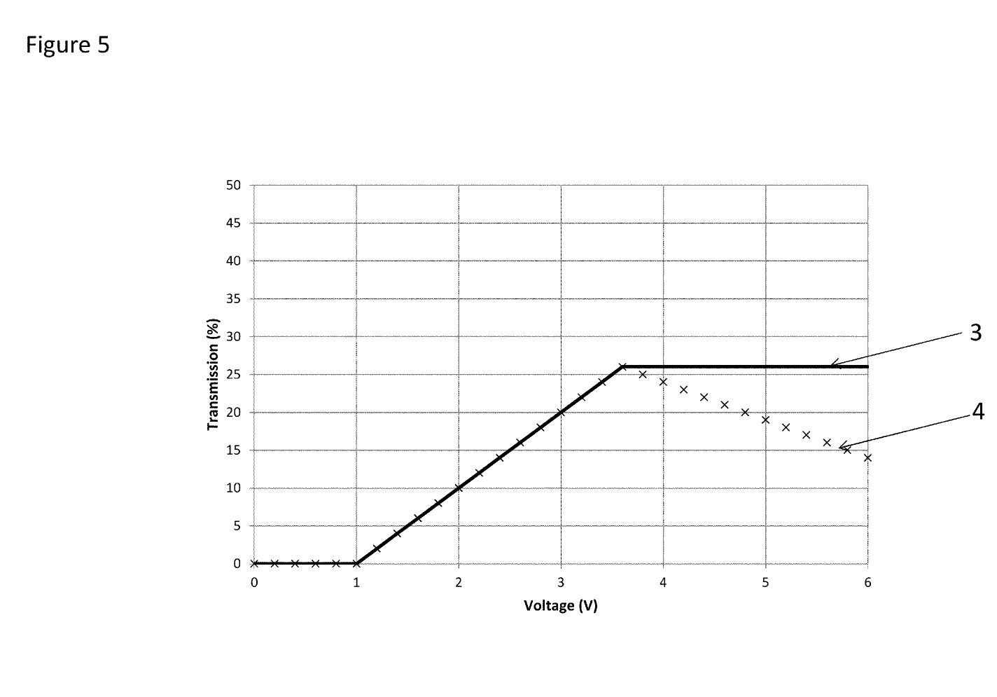

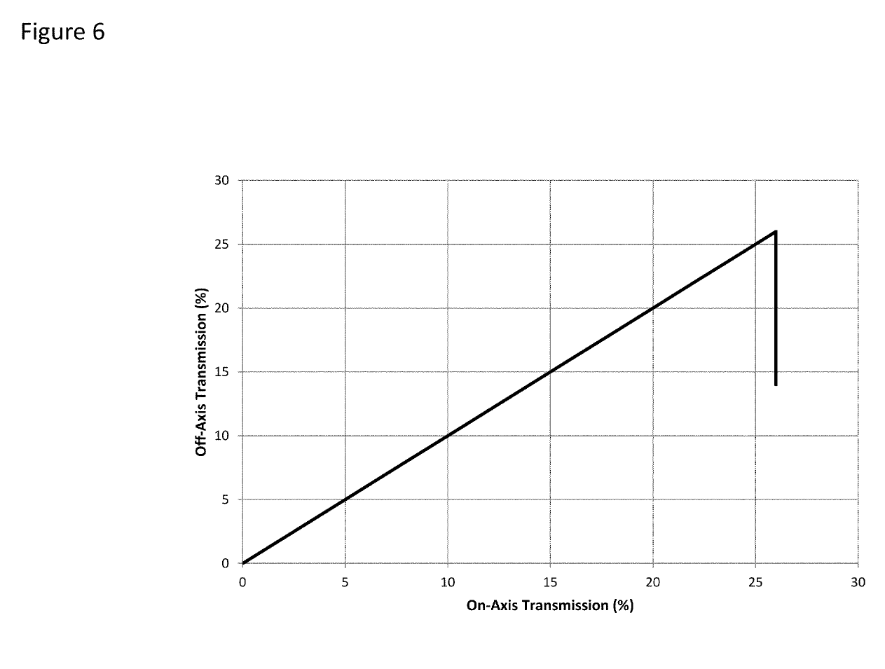

The invention is not limited to a display having the transmissivity against voltage characteristics of FIG. 3—as noted, the invention requires only that a display has two (or more) different configurations which display the same, or nearly the same, off-axis luminance but which display different on-axis luminances. FIG. 5 shows transmissivity against voltage characteristics of another display which could show a privacy effect. The full line 3 shows the on-axis transmissivity, and the xxxx line 4 shows the off-axis transmissivity. By driving the display at, for example, 2.5V for an OFF state and 6V for an ON state, an on-axis contrast ratio of 1.7:1 can be achieved, with an off-axis contrast ratio of 1:1, which gives complete privacy. This is further shown in FIG. 6 which is a plot of the off-axis transmission of FIG. 5 against the on-axis transmission of FIG. 5.

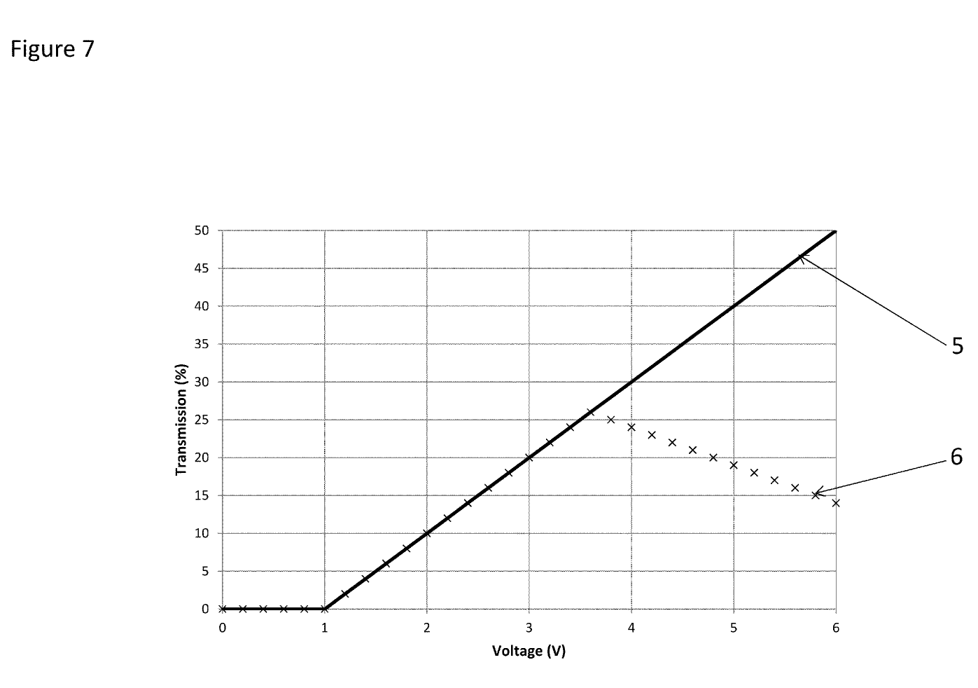

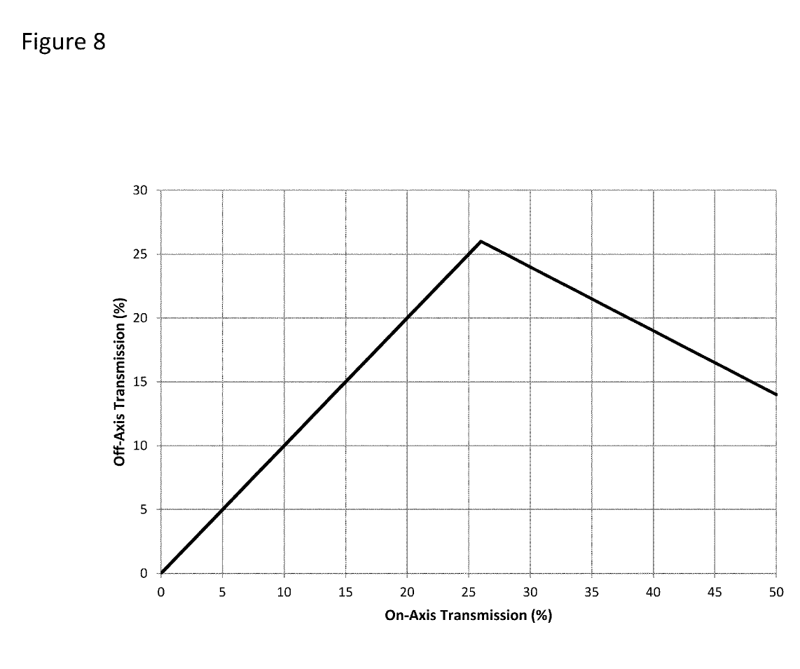

FIG. 7 shows transmissivity against voltage characteristics of another display which could show a privacy effect. The full line 5 shows the on-axis transmissivity, and the xxxx line 6 shows the off-axis transmissivity. By driving the display at for example 2.5V for an OFF state and 6V for an ON state, an on-axis contrast ratio of 3.3:1 can be achieved, with an off-axis contrast ratio of 1:1, which gives complete privacy. This is further shown in FIG. 8 which is a plot of the off-axis transmission of FIG. 7 against the on-axis transmission of FIG. 7.

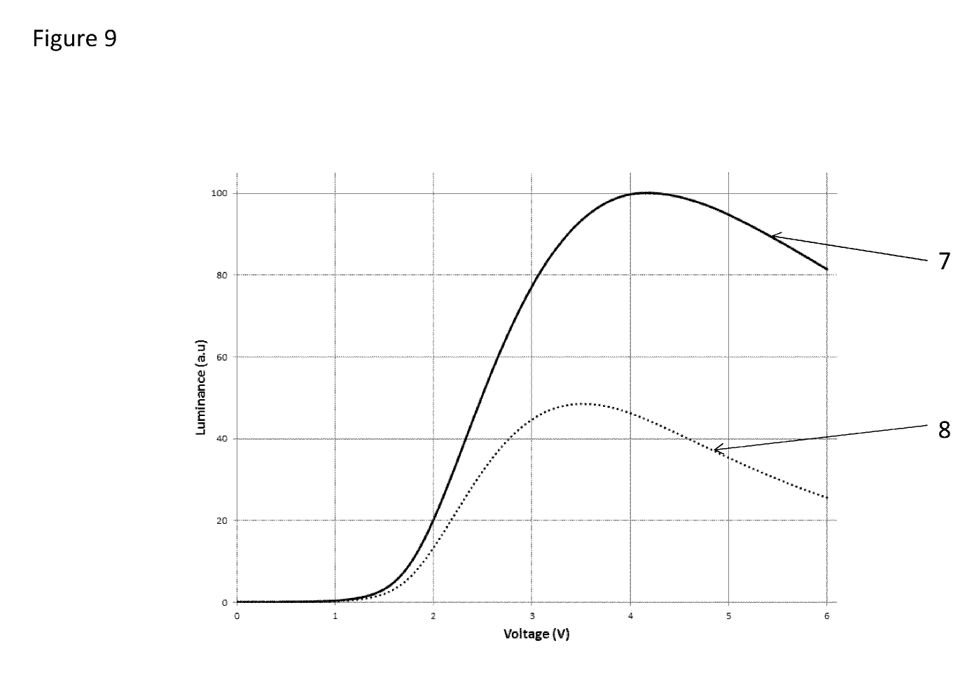

FIG. 9 shows transmissivity against voltage characteristics of another display which could show a privacy effect. The full line 7 shows the on-axis transmissivity, and the broken line 8 shows the off-axis transmissivity In this embodiment, the on-axis transmission of the spatial modulator is continuously variable and increases up to a maximum transmission at a certain configuration of the modulator (eg at a certain applied voltage), while the off-axis transmission follows a similar trend. If the configuration parameters are changed further, the relative change of the on-axis and off-axis transmissions are no longer similar. The transmission visible to a viewer situated in an off-axis viewing position might be similar to the transmission visible to the same viewer for a certain alternate configuration of the spatial modulator, typically from the range of configurations which were used before the maximum transmission was reached. With these two different configurations, which typically have different transmission levels visible to a viewer in an on-axis viewing position and the same transmission level visible to a viewer in an off-axis position, it is possible to create a very strong privacy effect while maintaining a favourable on-axis appearance.

It will be seen that the transmissivity against voltage characteristics of FIG. 9 would in principle be suitable for use with a prior art method that uses different electrode voltages which result in the same apparent on-axis luminance but lead to different off-axis luminances. However, this is only possible for on-axis luminances of 81% or above, since luminances below 81% are produced only by a single value of applied voltage (within the range 0V to 6V). Using the prior art method to obtain a privacy effect would therefore lead to an on-axis image whose luminance was limited to the range from 81% to 100%, which would give a low quality image, with an on-axis contrast ratio of just 1.23:1.

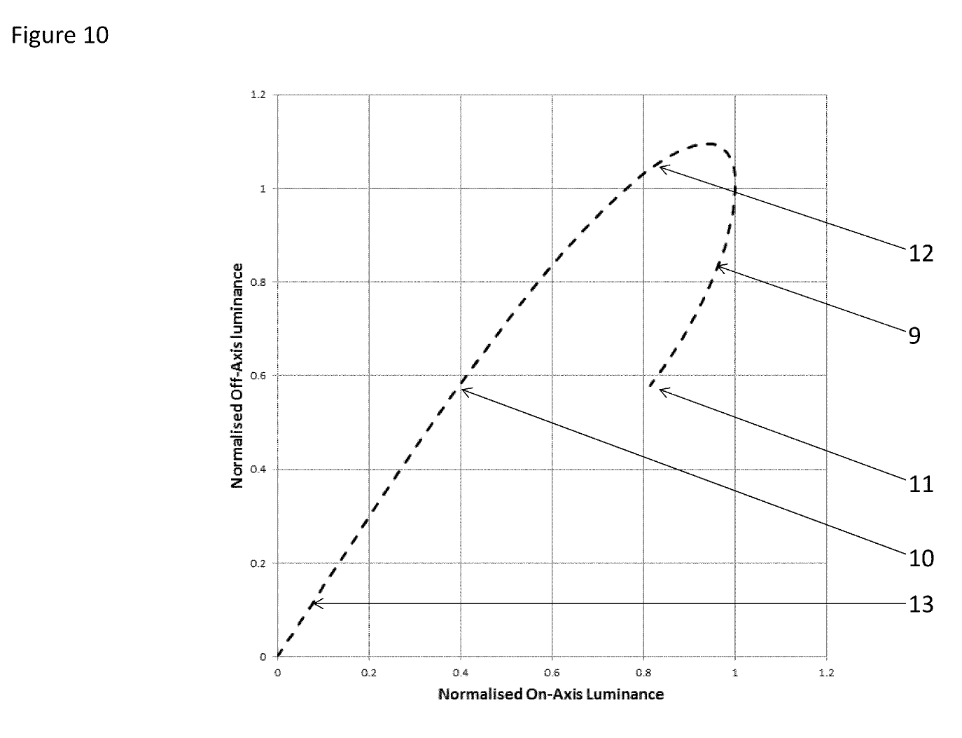

The simplest case relates to the display of a black and white picture, in which every part of it is either white or black—that is, there are no intermediate levels, or greyscales. By configuring the spatial modulators corresponding to the black areas of the picture to the configuration which gives a lower on-axis transmission, and by configuring the spatial modulators corresponding to the white areas of the picture to the configuration which gives a higher on-axis transmission, then to a viewer located in an off-axis viewing region, all areas of the picture will have the same apparent brightness—effectively it will all look uniformly grey. To a viewer located in an on-axis viewing position however, the picture will still be displayed completely accurately. The quality of the apparent on-axis picture will depend on many factors, and the choice of which configurations are used will likely include the resulting on-axis appearance, as well as other factors such as the ability and ease of the display device to display the two chosen configurations, and the resultant privacy strength. This embodiment is further shown in FIG. 10, in which configuration 10 and configuration 11 have the same off-axis luminance, but markedly different on-axis luminance; by matching black data levels to configuration 10 and white data levels to configuration 11, a privacy display with a narrow on-axis viewing region is achieved. In this case, the off-axis contrast ratio (at this viewing angle) will be exactly 1:1, while the on-axis contrast ratio will be 2.1:1.

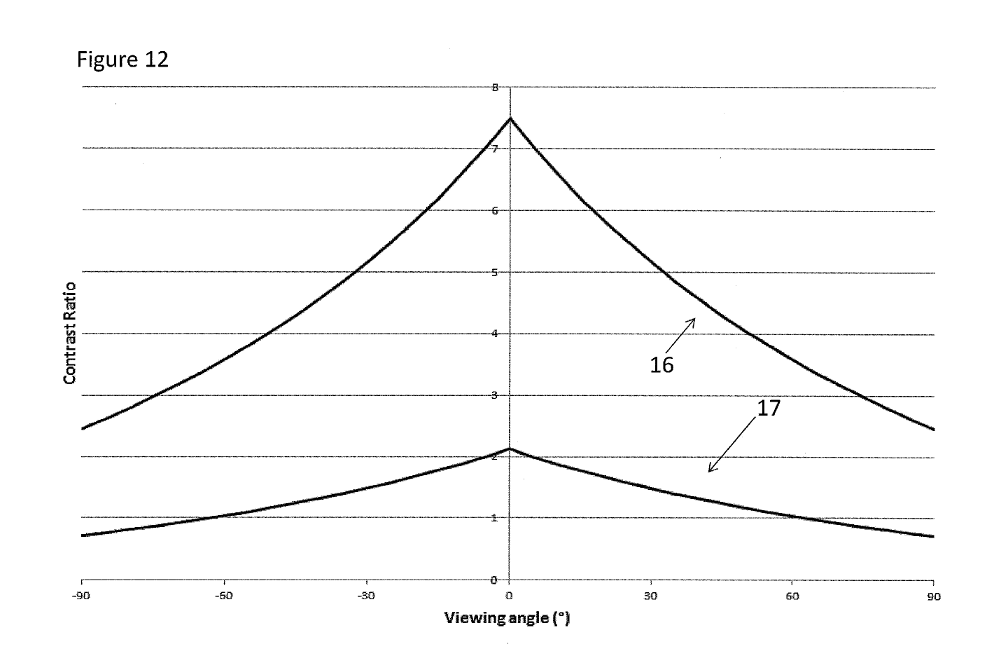

This effect is also shown in FIG. 12—if configurations 10 and 11 of FIG. 10 are used, then the contrast ratio at a range of viewing angles is shown by line 17. If, instead, configurations 13 and 11 of FIG. 10 were used, then the corresponding contrast ratio at a range of viewing angles is shown by line 16. In this case it is not possible to obtain a privacy effect since the contrast ratio given by configurations corresponding to line 16 is never less than 2.5 over the entire viewing angle range from −90° to +90°.

The effect of FIG. 12 may be used to provide a display that is switchable between a public display mode and a private display mode—the choice of configurations corresponding to line 16 will give a public display mode, while the choice of configurations corresponding to line 17 will give a private display mode. Such as display may be implemented by providing two look-up tables, one to convert input data to drive signals corresponding to line 16 and a second look-up table to convert input data to drive signals corresponding to line 17. A private display mode or a public display mode may be selected by choice of the appropriate look-up table. The selection between a private display mode or a public display mode may be made in any suitable way; for example a separate “public/private” signal may be supplied to the display, or the device may make the selection based on content of the image.

It is not always the case that for a chosen pair of configurations, the grey image apparent to off-axis viewers, will be uniformly grey. In particular, as the angle at which an off-axis viewer views the screen changes, the display device may start to reveal some of the content which is intended to be hidden from an off-axis viewer. More particularly, the contrast ratio may be continuously changing with viewing angle, as depicted in FIG. 12. This is particularly the case when the viewing zone of the off-axis viewer approaches the viewing zone of the on-axis viewer. In practice, there may only be one inclination angle at each azimuth for which the display device shows a complete privacy effect and at all other inclination angles the privacy strength will be reduced (for example in FIG. 12, for configurations corresponding to line 17 a complete privacy effect is obtained only at a viewing angle of 60°). Therefore, when choosing the pair of configurations for the private mode, it might be necessary to choose a target angle, at which a viewer will be completely unable to see the intended screen image, and it will be necessary to accept that there will be reduced privacy if the off-axis viewer moves away from this target viewing angle. This target angle may be chosen so that the image becomes sufficiently invisible at a small enough angle to the display normal to provide adequate privacy, but is still sufficiently large so that the image does not become unacceptably visible at larger viewing angles until the viewing angle is close enough to 90 degrees to make the image impossible to observe anyway.

In a further variant, it might be desired by the user to choose a pair of configurations such that the privacy effect is nowhere complete, or is complete only at very large angles. Further, it might be found that achieving a privacy effect in a viewing zone near to the on-axis viewer's viewing zone, is very difficult without significant degradation to the on-axis appearance of the display. Or in another case, the device might not be able to display a complete privacy effect (defined as an off-axis contrast ratio of 1:1) at a standard off-axis angle)(<90°. Another alternative is that the degradation in on-axis image quality is so significant that the on-axis viewer is willing to accept a lower level of privacy, in exchange for an improved on-axis appearance. Therefore, it is possible, and in many cases desirable, to choose any pair of configurations, which will have a certain appearance across a range of angles, according to certain criteria.

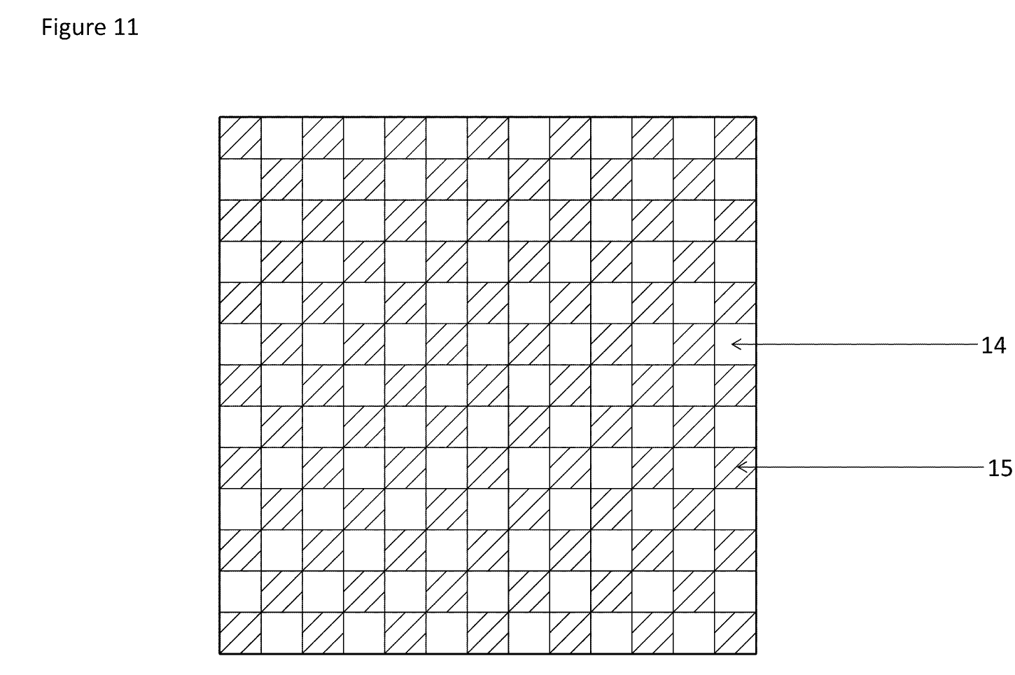

In another embodiment, when there are as few as two desirable configurations (that is, configurations that have the same or nearly the same off-axis transmissivity but that have different values of on-axis transmissivity), it may be preferable to use other, nonoptimal configurations at the same time. In particular, there exist methods to increase the privacy effect, apart from matching the off-axis appearance of configurations used to provide an on-axis image. In a further embodiment, a third configuration is utilised, which has the property of having the same on-axis transmission as one of the two previously utilised configurations. Thus, the embodiment of FIG. 10 has been described above as using the configurations 10 and 11 (to obtain low and high on-axis transmissivity respectively, while keeping the off-axis luminance approximately constant), while providing good privacy as the configurations 10 and 11 give the same off-axis transmissivity as one another. In an extension of this embodiment, a third configuration is also used, having the same on-axis transmissivity as one of the two previously-utilised configurations 10, 11—such as, for example, configuration 12 shown in FIG. 10, which has the same on-axis transmissivity as configuration 11 but a different off-axis transmissivity. One advantage of using this additional configuration is that, for a certain input (which might correspond to “black” or “white”, depending on which configuration's on-axis appearance is being matched) it is possible to show some regions of the picture where this data level is present, in one configuration, and the other regions in the other configuration. In this way, they will everywhere appear uniform to an on-axis viewer, which is desirable, but they will have different off-axis transmission levels. In the specific example of FIG. 10, the configurations 11 and 12 both correspond to “white”, so a “white” pixel of an image may be displayed using either configuration 11 or configuration 12—which present different brightness levels to an off-axis observer although they both present the same brightness level to an on-axis observer Therefore, an off-axis viewer who expects to see two different brightness levels, corresponding to black and white, does indeed see two different brightness but they in fact correspond to different parts of the same black level or white level as perceived by an on-axis viewer. The on-axis viewer may choose a certain pattern which specifies which pixels are shown with which of the two configurations which give identical on-axis appearance but different off-axis appearances, and so choose the image that is seen by an off-axis viewer. An example pattern is given in FIG. 11, in which shaded areas 15 correspond to using one set of configurations (in this example, 10 for Black and 11 for White) while clear areas 14 correspond to using a different pair of configurations (in this example, 10 for Black and 12 for White). That is, a third drive signal (to obtain configuration 12) is used in addition to the first and second drive signals (to obtain configurations 10 and 11), with the third drive signal driving, in use, a pixel or group of pixels of the display panel to produce the same on-axis luminance value as the first drive signal and driving, in use, the pixel or group of pixels of the display panel to produce a different off-axis luminance value to the first drive signal. Whether to drive a pixel or group of pixels of the display with the first drive signal or the third drive signal may be selected in accordance with a first predefined pattern, for example such as the pattern of FIG. 11. This pattern may be thought of as a “confusing pattern” (since its purpose is to confuse the image seen by an off-axis viewer) or a “masking pattern”.

It is apparent that, if only one of the configurations used to display the on-axis image has a corresponding configuration with the same on-axis transmission level but a different off-axis transmissivity (as in the example of FIG. 10, in which only configuration 11 has a corresponding configuration since there is no other configuration that gives the same on-axis transmissivity as configuration 10), such that there are only three configurations used in the whole display device, then the presence or absence of a pattern in certain regions might reduce the privacy effect. This can be mitigated by careful choosing of the pattern, or by dynamically updating the pattern to increase the privacy effect, such as through analysing the image contents. In particular, the privacy effect will be reduced in regions of the image in which the majority of the image content corresponds to the configuration for which a matching alternative is not available. Image analysis might help by altering the pattern near to these more uniform regions, such that the privacy effect incorporates these regions. For example, if there is a mostly black circle in the center of the image, then a pattern incorporating concentric circles centered on this feature, might trick the off-axis viewer into thinking that this dark circle in the center is in fact part of the privacy effect. If image analysis is not available, the confusing pattern can still be chosen to provide resilience against a variety of such privacy-reducing features.

The above example describes how the two basic configurations that provide low and high on-axis transmissivity respectively, while giving the same off-axis transmissivity as one another, may be supplemented by a third configuration having the same on-axis transmissivity as one of the two previously-utilised configurations. This may be further extended—in a case where both of the two basic configurations have an alternative configuration available (that provides the same on-axis transmissivity but a different off-axis transmissivity), it is possible to have an even stronger privacy effect, where the image visible to a viewer in the off-axis region will simply be a pattern chosen by the on-axis viewer, instead of what the on-axis viewer can see. Ideally, the fourth configuration would have the same off-axis transmissivity as the third configuration so that an off-axis viewer would see only two brightness levels—one corresponding to the first and second configurations and the other corresponding to the third and fourth configurations. That is, this embodiment further uses a fourth drive signal (to obtain the fourth configuration) that drives, in use, the pixel or group of pixels of the display panel to produce the same on-axis luminance value as the second drive signal and that drives, in use, the pixel or group of pixels of the display panel to produce a different off-axis luminance value to the second drive signal. Whether to drive a pixel or group of pixels of the display with the second drive signal or the fourth drive signal may be selected in accordance with a predetermined pattern—and, if so, this predetermined pattern may be the same as the first predefined pattern used to select whether to drive a pixel or group of pixels of the display with the first drive signal or the third drive signal, or it may be different from the first predetermined pattern.

In this embodiment the third and fourth drive signals may drive the pixel or group of pixels of the display panel to produce the same or similar off-axis luminance values as one another. However, it may be that the two corresponding alternative configurations do not have identical off-axis appearances to each other, and so the off-axis viewer will see three brightness levels—the original level (which may appear to the on-axis viewer as either black or white), and the two brightness levels originating from the alternative configurations. This might reduce the privacy effect, compared to an ideal case where the fourth configuration has the same off-axis transmissivity as the third configuration, although it is possible that there might exist a certain angle at which the two alternative configurations appear identical to the off-axis viewer, different to another certain angle at which the two principal configurations appear identical to an off-axis viewer. Careful selection of the principal configurations, and their corresponding alternative configurations, can improve the privacy effect across a range of angles. In particular, careful analysis of the transmissivity levels of the standard configurations and of their matching alternative configurations across a range of viewing angles, will reveal that in each pair of configurations corresponding to different on-axis transmissivity levels, the off-axis transmissivity may only be equal at a certain range of viewing angles, and at other viewing angles a difference between them will be perceptible to an off-axis viewer. In this case, it may be preferable to choose the configurations such that across a wide range of viewing angles, at least one of the configuration pairs has a strong privacy effect. Which will result in a good privacy effect.

Moreover, the invention is not limited to the use of two, three or four drive signals to obtain two, three and four configurations. Five configurations, or even more configurations may be used in other embodiments. For example, the drive signals may further include a fifth drive signal (to obtain the fifth configuration) that drives, in use, the pixel or group of pixels of the display panel to produce the same or similar off-axis luminance value as the first and second drive signals and that drives, in use, the pixel or group of pixels of the display panel to produce an on-axis luminance value different to the on-axis luminance value provided by the first drive signal and different to the on-axis luminance value provided by the second drive signal.

For simplicity the description of the above embodiments has considered display of an image that has just two brightness levels, ie ON and OFF (or “black” and “white”). The invention is not however limited this, and in further embodiments the image which the user intends to display on the screen may not be in a simple black and white format. In particular, the image content may include multiple colours, and/or there may be intermediate levels of brightness between maximally dark and maximally bright. In the case that there are multiple colours, the previously disclosed methods for providing privacy may possibly be used without further modification, since colours are generally displayed by filtering out certain wavelengths of the light that would otherwise be visible on the display device.

However, it may be the case that certain configurations will not work identically for different colours, for example if the spatial modulators have colour-dependent transmission levels. Therefore, it may be necessary to select different sets of configurations for different colours. However, in a further variant, it may be preferable to select a pattern for providing off-axis privacy which is colour-dependant, such that the decision on whether a certain spatial modulator should be configured in the original configuration or in the alternative configuration will, in addition to other dependencies, depend on its colour channel.

When the incoming image data includes greyscale content, in that there is data between the maximally on level and the maximally off level, there are different ways in which methods of the invention may be used to produce a privacy effect.

A method of the invention therefore may additionally or alternatively comprise compressing all of, or at least a predetermined proportion of, the image pixel data; and performing, in the private mode (first mode), the mapping from image pixel data to drive signals on the compressed image pixel data. For example, if there are n drive signals, n>1, that drive the display panel to produce the same or similar off-axis luminance values and that drive the display panel to produce n different on-axis luminance values, the image pixel, or at least the predetermined proportion of the image pixel data, may be compressed into the n different on-axis luminance values. The compressed data may then be displayed using the n drive signals, and an on-axis viewer will see the desired image while an off-axis viewer will see a substantially uniform luminance. In one example n=2, which corresponds to compressing the image to binary form (so that a pixel luminance can take one of only two grey-scale values, usually the maximally bright and minimally bright states), and in another example n>2 (see below).

In one method, it is possible to specify that for each data level, one set of configurations will be used, with the choice of which particular configuration to use depending on factors such as the direction of the confusing pattern. However, there may be a problem that not all configurations will have a corresponding alternative; in this case, it may be necessary to reduce the image quality of the screen apparent to the on-axis viewer in order to allow for alternative configurations. In particular, it may be necessary to scale the brightness of the image such that for all used image content levels, their corresponding configurations have alternate configurations available.

Another method of providing a good privacy effect for images with intermediate brightness levels, involves manipulating the image in order to achieve a strong privacy effect and still show a high quality image to the on-axis viewer. One such image manipulation technique is to convert the image to an image without any intermediate brightness levels, to therefore be compatible with the methods of previous embodiments, using a procedure such as dithering. There are several well-known dithering algorithms, such as error-diffusion dithering, and ordered dithering, which will manipulate the image data in such a way that the perceived change to viewers located in any viewing region, caused by the dithering process, will be minimised. In error-diffusion dithering, the image is scanned, typically in rows, and each pixel is shifted to either black or white, depending on which level is the closer. Then, the error caused by this shift, is passed on nearby pixels, such that in total the luminance of this area of the screen will be unchanged. As an example, if a block of pixels are all at 60% luminance, then the first pixel will be shifted to 100% luminance, and (for example) 4 surrounding pixels (typically the next pixel in the row, and the three pixels in the following row whose middle one is underneath the current pixel) will between them absorb the 40% error. This may be as simple as all four of them becoming 50% luminance, or, more commonly, they will be given a weighted fraction of the total error. Then the next pixel will again be shifted to 100%, and by propagating the error term, two of the pixels which were previously made to 50%, will now be made to 37.5% (one quarter of the 50% error is being subtracted from each one). Then, depending on whether they are further changed before they are processed, they will shift to a dark state at 0%, even though originally they were at 60% which would correspond to a white state. In this way, in exchange for a resolution loss, each pixel can be converted into a black or white pixel. In a case where the image has colours, the dithering algorithm can be applied to each colour channel separately. The error term can be propagated to the nearby matching subpixels, or in more advanced dithering algorithms the other colour channels can be affected also. Another dithering algorithm, known as ordered dither, would also work well in this embodiment, and has particular advantages over error-diffusion dithering, particularly in image quality and complexity. In an ordered dither process, of which several well-known variations exist, the main image data is compared to a matrix mask of integer values, and for those pixels where the main image data value is higher than its corresponding entry in the matrix mask, the pixel is set to maximum, and where the value is lower, it is set to minimum. This matrix is often a square matrix with 16 or 64 entries in, arranged in such a way as to reduce visible artefacts across a range of brightness levels. The matrix is then repeated throughout the whole image. In the case of the 16 entry matrix, this means that when scanning a line in the display electronics, the four entries from that row of the matrix are repeated, such that each pixel is compared to one of the four entries. Then in the next row, the next row of the matrix is used, and so on. It is clear that there is a very low memory requirement for this dithering implementation. When deciding the size of the matrix, there are trade-offs to consider, particularly between the apparent bit-depth of the resulting dithered image, and the visibility of the artefacts which depends heavily on the pixel density of the display. As well as the reduced memory and processing resource requirement, the ordered dither has the advantage that the resulting pattern of brighter and darker pixels in the output image is always fixed for a given input image value, so for video inputs, the dither pattern of sequential frames of similar content remains static and does not shimmer as can be the case for error diffusion dithering.

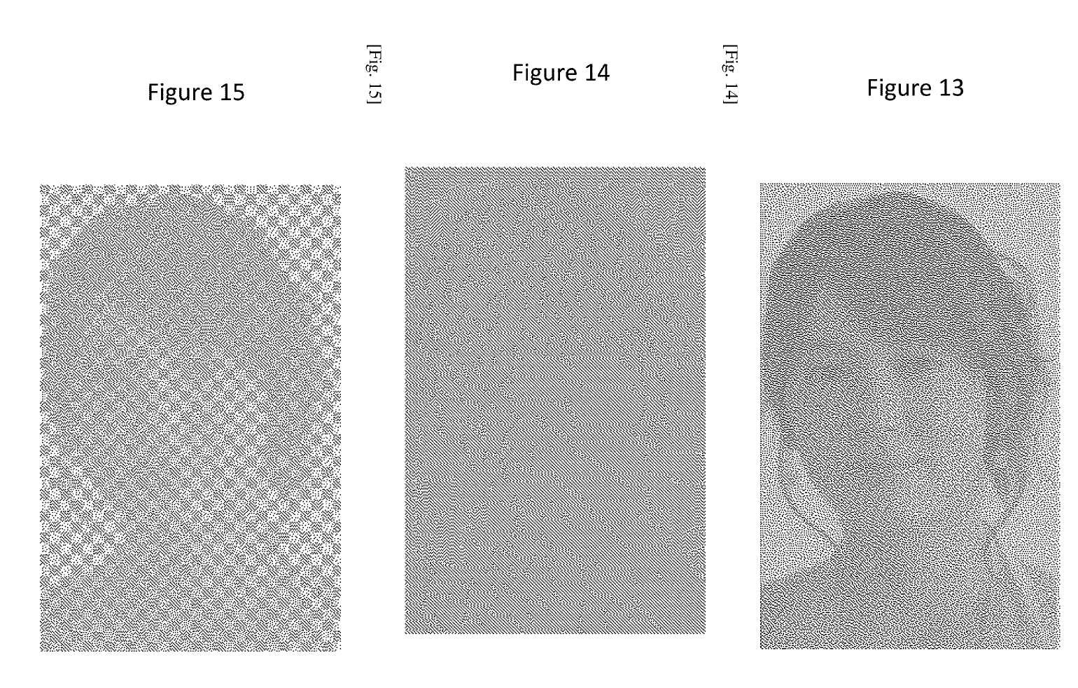

An image that has been dithered using error-diffusion dithering is shown in FIG. 13, as it might appear to an on-axis viewer using the private mode. The corresponding appearance to a viewer located off-axis is shown in FIG. 14, and the corresponding appearance to a viewer located off-axis using a private mode with side image masking, is shown in FIG. 15.

If the image has been converted into a binary form (that is, to include only maximally on and maximally off levels), such as through the use of a dithering technique, then as disclosed in previous embodiments it can be shown on the screen in such a way as to be incomprehensible to viewers in a certain off-axis region, through careful selecting of the spatial modulators' configurations.

There exists a further embodiment, in which there exists more than one resultant on-axis transmission level which can be produced by two or more distinct configurations with resulting unique off-axis transmissions. In this case, it may be beneficial to select a subset of these useful configurations, and dither the image such that it has a number of data levels equal to the number of selected configurations, and such that the data levels correspond to the on-axis transmission levels of the selected configurations. In this way, the image can be displayed faithfully to the on-axis viewer, and maintain a high degree of off-axis privacy, and yet it may possess preferable characteristics, such as improved privacy strength or improved on-axis appearance, than the case in which only two data levels are used.

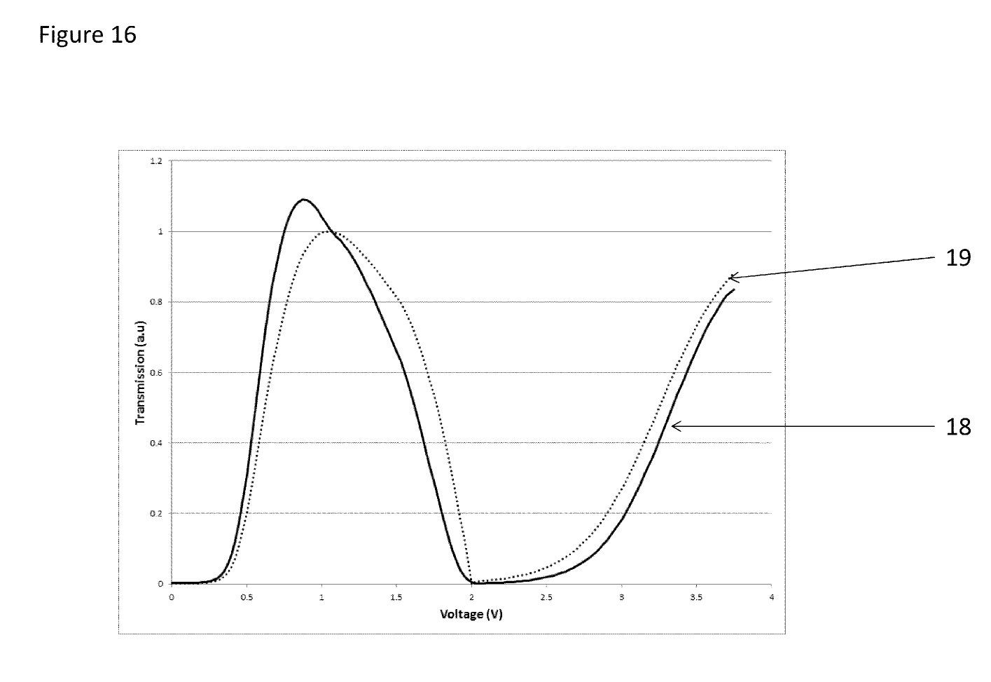

This example is illustrated in FIG. 16, which shows transmissivity against voltage characteristics of a display which could use this embodiment. The full line 18 shows the on-axis transmissivity, and the dotted line 19 shows the off-axis transmissivity. As can be seen, there are three different configurations (corresponding to three different applied voltages) for each on-axis transmission level (up to a maximum, of 0.83 here), and these three different configurations provide the same on-axis transmission level but with three different off-axis transmission levels. Conversely, for each off-axis transmission level (up to a maximum, in this case of around 0.85), there are three different configurations that provide this off-axis transmission level but provide different on-axis transmission levels. Thus, if an image is dithered to these three levels, the image may be displayed using these three configurations—and as all three configurations provide the same off-axis transmission, all parts of the image will look uniform to an off-axis viewer. For example, an off-axis transmission of 0.6 is provided by three configurations, which provide on-axis transmissions of approximately 0.8, 0.35 and 0.5. Thus, an image may be dithered to the three levels of 0.35, 0.5 and 0.8 which are then displayed using these three configurations—and an off-axis viewer will perceive a uniform transmission of 0.6. Thus, this corresponds to the previous embodiment, but the greyscale content has been compressed into 3 different on-axis luminance values (that is, n=3).

In a specific implementation of the primary embodiment, the display is a Fringe Field Switching (FFS) Liquid Crystal Display (LCD), with many pixels able to display a range of colours, with each pixel being made up of subpixels which can only show one colour each. The spatial modulator is a liquid crystal layer, with an electrode in each subpixel, selectively transmitting a proportion of the light incident upon it, according to the electric field generated when a voltage is applied to the electrode. As the voltage across the electrode increases, the liquid crystals will tend to rotate, such that more light is transmitted. In this implementation, when the liquid crystals reach a rotation of approximately 45°, a maximum transmission level is reached. However, due to the structure of this FFS display, the maximum off-axis (here defined as 60°) transmission is reached at a different LC rotation, although this is not a necessary requirement of the present invention. This transmission-voltage relationship is shown in FIG. 9, and the on- and off-axis luminance available at all possible configurations are shown in FIG. 10. The maximum on-axis luminance, corresponding to line 7, is reached at a voltage of 4.2V. As the voltage increases further, the on-axis transmission drops, and so does the off-axis transmission, but at a different rate, and after it has reached its own maximum transmission level, which is here 3.5V, according to line 8. At 6V, the on-axis transmission is 81% of its maximum, and the off-axis transmission is at 58% of maximum. This is the configuration corresponding to point 11. The other voltage level which gives this off-axis transmission is 2.3V, which results in an on-axis transmission of 38% of its maximum. This is the configuration corresponding to point 10. A third configuration, at 3.1V, has an on-axis transmission of 81% and an off-axis transmission of 100% of maximum; this point corresponds to the second of two choices if a confusing pattern is being used. This is the configuration corresponding to point 12. These luminance levels are demonstrated in simulated images, where FIG. 13 corresponds to the public mode, FIG. 14 corresponds to the private mode using only two configurations, and FIG. 15 corresponds to the private mode using three configurations and a confusing pattern.

The invention has been described above with reference to examples in which a respective drive voltage for each pixel has been derived solely from the image pixel data for that pixel. The invention is not however limited to this, and it is alternatively possible to derive a drive voltage for a pixel by taking account of the desired average on-axis luminance of a group of adjacent pixels, which includes the pixel, as well as the image pixel data for that pixel.

For example, in the private display mode the image pixel data for a group of adjacent pixels of the display may be mapped such that, in use, the pixels of the group are driven such that an average on-axis luminance value of the group of pixels is dependent mainly on the image pixel data, and such that every pixel of the group of pixels produces the same or similar off-axis luminance values at at least one off-axis viewing angle. As noted above, it has been suggested that the prior art requirement for there to be, for each required on-axis luminance value, at least two configurations that provide the required on-axis luminance value may be met by grouping pixels—but this uses pixel averaging for both on-axis and off-axis luminance.

As another example, the image pixel data may be mapped in the private display mode to pixel drive voltages such that, in use, the pixels in a group of adjacent pixels are driven such that an average on-axis luminance value of the group of pixels is dependent mainly on the image pixel data for the pixels of the group. In this method the average on-axis luminance value of the group of pixels may be intermediate between the maximal on-axis luminance value and the minimal on-axis luminance value. This allows the display of intermediate luminance levels, albeit at the expense of a loss of resolution caused by the averaging of luminance over a group of adjacent pixels.

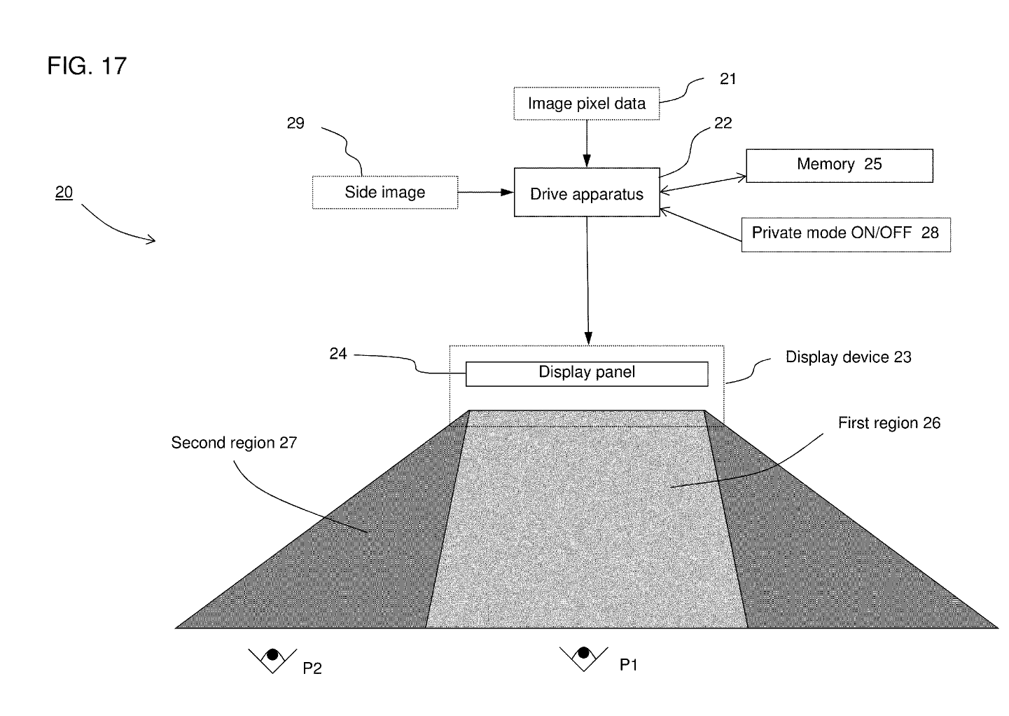

FIG. 17 is a schematic block diagram of an image display system 20 embodying the present invention. The image display system 20 includes a display device 23 having a display panel 24, and also includes a drive apparatus, or drive controller, 22 that provides drive signals to the display panel 24. The display panel 24 may be a liquid crystal display panel, although the invention is not in principle limited to use with a liquid crystal display panel.

FIG. 17 shows the drive apparatus or drive controller 22 as separate from the display device 23, but the invention is not limited to this and the drive apparatus or drive controller 22 could alternatively be provided within the display device 23.

The drive apparatus 22 receives a sequence of sets of image pixel data 21, where each set of image pixel data represents an image that is intended to be displayed on the display panel 24. A set of image pixel data 21 may represent a still image, or may represent a respective frame of an image in the case of a video image.

The drive apparatus or drive controller 22 maps each received set of image pixel data to drive signals (eg drive voltages) for driving a respective pixel or group of pixels of the display panel 24 such that, when the drive signals are supplied to the display panel 24, the display panel 24 displays an image corresponding to the respective set of image pixel data.

The drive apparatus or drive controller 22 operates at least in a first, or “private”, mode in which the mapping of a set of image pixel data to drive signals is arranged such that, when the drive signals are supplied to the display panel 24, the display panel 24 produce an on-axis luminance pattern which is dependent mainly on the image pixel data and an off-axis luminance pattern which is wholly or substantially independent of the image pixel data. Thus an observer P1 who views the display panel in a substantially on-axis direction (that is, who views the display at or close to the normal direction) can perceive the image, whereas another observer P2 who views the display panel in a substantially off-axis direction cannot perceive the image. When the drive apparatus or drive controller 22 operates in the first, private mode, a displayed image is visible to an observer located in a first, narrow viewing region 26 but an observer outside the first, narrow viewing region 26 will see the off-axis luminance pattern which is wholly or substantially independent of the image pixel data.

The drive apparatus or drive controller 22 carries out the mapping from received image pixel data to drive signals by, for a pixel or group of pixels, mapping the image pixel data for the pixel or group of pixels to one of a first plurality of preselected drive signals including at least first and second pre-selected drive signals that drive, in use, the pixel or group of pixels of the display panel to produce different on-axis luminance values and that drive, in use, the pixel or group of pixels of the display panel to produce the same or similar off-axis luminance values. The display panel may for example have a luminance characteristic that corresponds to any of the embodiments described hereinabove, in particular may have a luminance characteristic generally as shown in any one of FIGS. 3 to 10, 12 and 16, and the drive apparatus or drive controller 22 may use drive signals as described in these embodiments. The drive apparatus or drive controller 22 may map the input pixel data to drive signals according to any one of the embodiments described above.

The preselected drive signals are preferably pre-stored in a memory 25 so that the drive apparatus or drive controller 22 can determine an appropriate drive signal from the received pixel data and retrieve the appropriate drive signal from the memory. In principle, however, the drive apparatus or drive controller 22 could generate a drive signal afresh each time.

As described above, in some embodiments the drive apparatus or drive controller 22 may be able to operate also in a second or “public” mode in which it performs a second mapping of the image pixel data to a second plurality of drive signals for driving the display panel, wherein the second mapping is arranged to produce an on-axis luminance pattern which is dependent mainly on the image pixel data and an off-axis luminance pattern which is dependent mainly on the image pixel data. When the drive apparatus or drive controller 22 operates in the public mode, a displayed image is visible to an observer located anywhere in a second, wide, viewing region 27 so observers P1 and P2 in FIG. 17 will both be able to perceive the image. If the drive apparatus or drive controller 22 is able to operate also in the second, “public” mode, the drive apparatus or drive controller 22 may, as indicated in FIG. 17, receive an input 28 that determines whether the drive apparatus or drive controller 22 operates in the public mode or the private mode. This input 28 may be provided in any suitable way, for example the input 28 may be provided manually by a user of the display system, or may be derived from the image pixel data 21.

As described above, in some embodiments a “side image” (or “confusing image”) may be used to further improve the privacy effect. Optionally, therefore, the drive apparatus or drive controller 22 may have an input for receiving a side image 29.

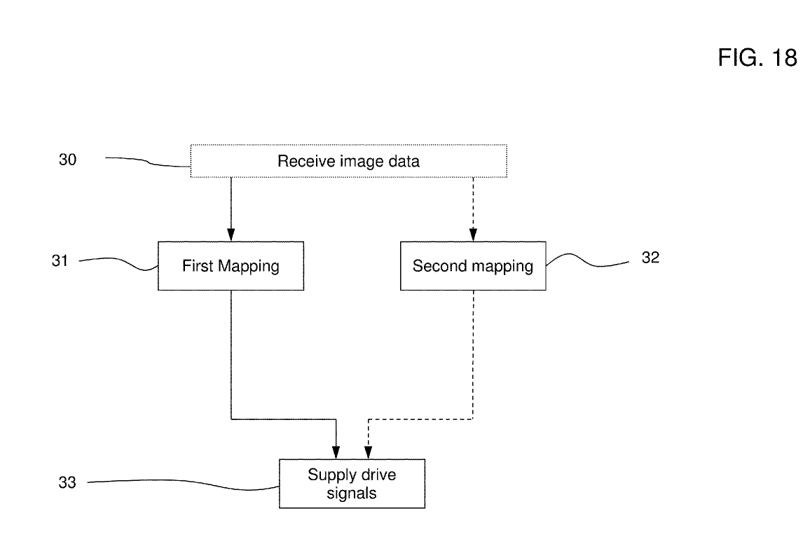

FIG. 18 is a schematic block flow diagram showing principal features of a method of processing image data for display by a display panel of a display device. At block 30, image pixel data representing an image are received, for example at a drive apparatus or drive controller 22 as shown in FIG. 17.

At block 31 a first mapping of the image pixel data to drive signals is performed. Each drive signal is for driving a respective pixel or group of pixels of the display panel. The first mapping is arranged to produce an on-axis luminance pattern which is dependent mainly on the image pixel data and an off-axis luminance pattern which is wholly or substantially independent of the image pixel data, and is arranged, for a pixel or a group of pixels, to map the image pixel data for the pixel or group of pixels to one of a first plurality of pre-selected drive signals including at least first and second pre-selected drive signals that drive, in use, the pixel or group of pixels of the display panel to produce different on-axis luminance values and that drive, in use, the pixel or group of pixels of the display panel to produce the same or similar off-axis luminance values at at least one off-axis viewing angle.

At block 33 the drive signals are supplied to a display panel for driving the display panel.

As described above, in some embodiments a method of the invention may be able to provide also a second or “public” mode. In such embodiments the method may comprise, as an alternative to block 31, performing at block 32 a second mapping of the image pixel data to a second plurality of drive signals for driving the display panel. The second mapping is arranged to produce an on-axis luminance pattern which is dependent mainly on the image pixel data and an off-axis luminance pattern which is dependent mainly on the image pixel data.

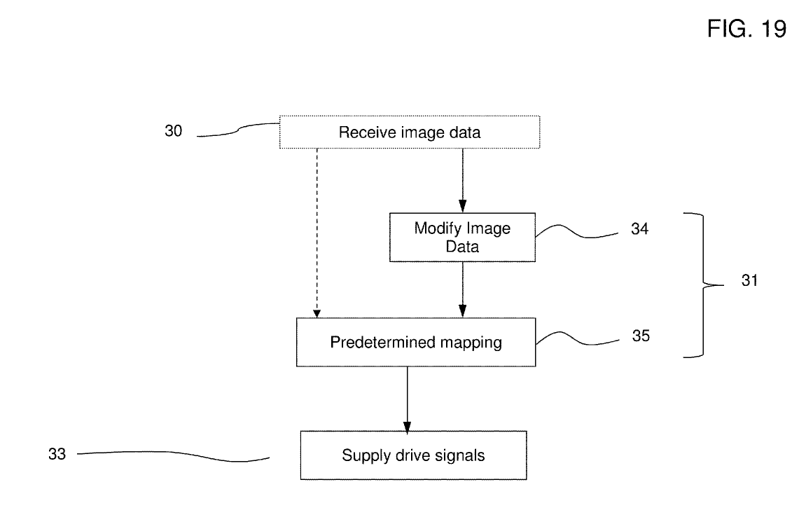

FIG. 19 is a schematic block flow diagram showing principal features of another method of processing image data for display by a display panel of a display device. At block 30, image pixel data representing an image are received, for example at a drive apparatus or drive controller 22 as shown in FIG. 17. At block 34 of FIG. 19 the image pixel data are mapped to modified image pixel data, and at block 35 a predefined mapping is applied to the modified image pixel data to map the modified image pixel data to drive signals. The combination of blocks 34 and 35 of FIG. 19 corresponds to block 31 of FIG. 18. Block 33 of FIG. 19 corresponds to block 33 of FIG. 18, and will not be further described.

The method of FIG. 19 may in a further embodiment be able to provide also a second or “public” mode. This may be effected by omitting the mapping of the image pixel data to modified image pixel data, so that the predefined mapping of block 35 is applied to the received image pixel as shown by the broken line in FIG. 19.

A method of the invention may be performed in a display device, or it may be performed external to the display device with the determined drive signals then being provided to the display device. An apparatus may be controlled to perform a method of the invention using a suitable program; such a program may be carried on a carrier medium, such as a storage medium or a transmission medium.

### INDUSTRIAL APPLICABILITY

The embodiments of this invention are applicable to many display devices, and a user may benefit from the capability of the display to switch between a private mode and a public mode. Examples of such devices include mobile phones, watches, Personal Digital Assistants (PDAs), tablets, laptop computers, desktop monitors, Automatic Teller Machines (ATMs), automotive displays, and Electronic Point of Sale (EPOS) equipment.

### REFERENCE SIGNS LIST

1. Simulated on-axis transmission across a range of voltages
2. Simulated off-axis transmission across a range of voltages
3. Simulated on-axis transmission across a range of voltages
4. Simulated off-axis transmission across a range of voltages
5. Simulated on-axis transmission across a range of voltages
6. Simulated off-axis transmission across a range of voltages
7. Luminance level visible to an on-axis viewer across a range of electrode voltages
8. Luminance level visible to an off-axis viewer across a range of electrode voltages
9. Chart showing resultant off- and on-axis luminance for different configurations
10. One target configuration, which has a corresponding off-axis luminance at another configuration (3)
11. The configuration which has the same off-axis luminance as (2)
12. The configuration which has the same off-axis luminance as (3)
13. One configuration, which lower on- and off-axis luminance than 10,11, and 12
14. Region of the screen in which one configuration will be used
15. Region of the screen in which another configuration will be used
16. Contrast ratios in one public mode
17. Contrast ratios in one private mode
18. Simulated on-axis transmission across a range of voltages
19. Simulated off-axis transmission across a range of voltages
20. Image display system
21. Image pixel data
22. Drive apparatus or drive controller
23. Display device
24. Display apparatus
25. Memory
26. Narrow viewing region
27. Wide viewing region
28. Private mode select
29. Side image
30. to 35 Features in methods according to embodiments of the invention

1. A method of processing image data for display by a display panel of a display device, the method comprising:
receiving image pixel data representing an image; and
in a first mode, performing a first mapping of the image pixel data to drive signals, each drive signal for driving a respective pixel or group of pixels of the display panel, wherein the first mapping is arranged to produce an on-axis luminance pattern which is dependent mainly on the image pixel data and an off-axis luminance pattern which is wholly or substantially independent of the image pixel data;
wherein the first mapping is arranged, for a pixel or a group of pixels, to map the image pixel data for the pixel or group of pixels to one of a first plurality of pre-selected drive signals including at least first and second pre-selected drive signals that drive, in use, the pixel or group of pixels of the display panel to produce different on-axis luminance values and that drive, in use, the pixel or group of pixels of the display panel to produce the same or similar off-axis luminance values at least one off-axis viewing angle.

2. A method as claimed in claim 1 wherein the first mapping is further arranged to map the image pixel data for a group of adjacent pixels of the display such that, in use, the pixels of the group are driven such that an average on-axis luminance value of the group of pixels is dependent mainly on the image pixel data and such that every pixel of the group of pixels produces the same or similar off-axis luminance values at least one off-axis viewing angle.

3. A method as claimed in claim 1 wherein the first plurality of pre-selected drive signals further includes a third drive signal that drives, in use, the pixel or group of pixels of the display panel to produce the same on-axis luminance value as the first drive signal and that drives, in use, the pixel or group of pixels of the display panel to produce a different off-axis luminance value to the first drive signal.

4. A method as claimed in claim 1 wherein the first plurality of pre-selected drive signals further includes a fourth drive signal that drives, in use, the pixel or group of pixels of the display panel to produce the same on-axis luminance value as the second drive signal and that drives, in use, the pixel or group of pixels of the display panel to produce a different off-axis luminance value to the second drive signal.

5. A method as claimed in claim 4 wherein the third and fourth drive signals drive, in use, the pixel or group of pixels of the display panel to produce the same or similar off-axis luminance values as one another.

6. A method as claimed in claim 1 wherein the first plurality of pre-selected drive signals further includes a fifth drive signal that drives, in use, the pixel or group of pixels of the display panel to produce the same or similar off-axis luminance value as the first and second drive signals and that drives, in use, the pixel or group of pixels of the display panel to produce an on-axis luminance value different to the on-axis luminance value provided by the first drive signal and different to the on-axis luminance value provided by the second drive signal.

7. A method as claimed in claim 3, further comprising selecting whether to drive a pixel or group of pixels of the display with the first drive signal or the third drive signal in accordance with a first predefined pattern.

8. A method as claimed in claim 4, further comprising selecting whether to drive a pixel or group of pixels of the display with the second drive signal or the fourth drive signal in accordance with either the first predefined pattern or a second predefined pattern.

9. A method as claimed in claim 1 wherein the first mapping is further arranged to map the image pixel data for a group of adjacent pixels of the display such that, in use, the pixels of the group are driven such that an average on-axis luminance value of the group of pixels is dependent mainly on the image pixel data and is intermediate between the on-axis luminance value corresponding to the first drive signal and the on-axis luminance value corresponding to the second drive signal.

10. A method as claimed in claim 1 and comprising: compressing all of, or at least a predetermined proportion of, the image pixel data; and performing the first mapping on the compressed image pixel data.

11. A method as claimed in claim 10 wherein, for at least one off-axis luminance value, there are n drive signals, n>1, that, in use, drive a pixel or a group of pixels of the display panel to produce said off-axis luminance value or a similar off-axis luminance value and that drive a pixel or a group of pixels of the display panel to produce n different on-axis luminance values;
and wherein compressing all of, or at least the predetermined proportion of, the image pixel data comprising compressing all of, or at least the predetermined proportion of, the image pixel data into the n different on-axis luminance values.

12. A method as claimed in claim 11, wherein n=2.

13. A method as claimed in claim 11, wherein n>2.

14. A method as claimed in claim 1 wherein performing the first mapping comprises mapping the image pixel data to modified image pixel data, and applying a predefined mapping to the modified image pixel data.

15. A method as claimed in claim 1, further comprising, in a second mode, performing a second mapping of the image pixel data to a second plurality of drive signals for driving the display panel, wherein the second mapping is arranged to produce an on-axis luminance pattern which is dependent mainly on the image pixel data and an off-axis luminance pattern which is dependent mainly on the image pixel data.

16. A method as claimed in claim 15, wherein performing the first mapping comprises mapping the image pixel data to modified image pixel data, and applying a predefined mapping to the modified image pixel data, and performing the second mapping comprises applying the predetermined mapping to the image pixel data.

17. An apparatus for processing image data for display by a display panel of a display device, the apparatus adapted to:
receive image pixel data representing an image; and
in a first mode, perform a first mapping of the image pixel data to drive signals, each drive signal used to drive a respective pixel or group of pixels of the display panel, wherein the first mapping is arranged to produce an on-axis luminance pattern which is dependent mainly on the image pixel data and an off-axis luminance pattern which is wholly or substantially independent of the image pixel data;
wherein the first mapping is arranged, for a pixel or group of pixels, to map the image pixel data for the pixel or group of pixels to one of a first plurality of pre-selected drive signals including at least first and second pre-selected drive signals that drive, in use, the pixel or group of pixels of the display panel to produce different on-axis luminance values and that drive, in use, the pixel or group of pixels of the display panel to produce the same or similar off-axis luminance values.

18. An apparatus as claimed in claim 17 and further adapted to map the image pixel data for a group of adjacent pixels of the display such that, in use, the pixels of the group are driven such that an average on-axis luminance value of the group of pixels is dependent mainly on the image pixel data and such that every pixel of the group of pixels produces the same or similar off-axis luminance values at at least one off-axis viewing angle.

19. An apparatus as claimed in claim 17 wherein the first plurality of pre-selected drive signals further includes a third drive signal that drives, in use, the pixel or group of pixels of the display panel to produce the same on-axis luminance value as the first drive signal and that drive, in use, the pixel or group of pixels of the display panel to produce a different off-axis luminance value to the first drive signal.

20-22. (canceled)

23. An apparatus as claimed in claim 19, further adapted to select whether to drive a pixel or group of pixels of the of the display with the first drive signal or the third drive signal in accordance with a first predefined pattern.

24-31. (canceled)

32. A display device comprising an apparatus as defined in claim 17, wherein, for at least one desired on-axis luminance, the display device does not have multiple pixel configurations that that give the desired on-axis luminance and give different off-axis luminances to one another.

33. A display device comprising:
an image display panel, wherein, for at least one desired on-axis luminance, the display device does not have multiple pixel configurations that give the desired on-axis luminance and give different off-axis luminances to one another;
a module for receive image pixel data representing an image; and
a module for, in a first mode, performing a first mapping of the image pixel data to drive signals used to drive a pixel or group of pixels of the display panel, wherein the first mapping is arranged to produce an on-axis luminance pattern for the display panel which is dependent mainly on the image pixel data and an off-axis luminance pattern for the display panel which is wholly or substantially independent of the image pixel data;

34. A program for controlling an apparatus to perform a method as defined in claim 1.

35. (canceled)
